(19) United States
(12) Patent Application Publication
(10) Pub. No.: US 2012/0253741 A1
(43) Pub. Date: Oct. 4, 2012

(54) CHECKING POSITIONAL ACCURACY OF FEATURES

(75) Inventors: Richard GREEN, Bristol (GB); Michael ANNEAR, Bristol (GB)

(73) Assignee: ROLLS-ROYCE PLC, LONDON (GB)

(21) Appl. No.: 13/431,541

(22) Filed: Mar. 27, 2012

(30) Foreign Application Priority Data
Mar. 31, 2011 (GB) 1105443.4

(51) Int. Cl. G06F 15/00; G01B 21/20

(52) U.S. Cl. 702/167

(57) ABSTRACT

A component such as a casing of a gas turbine engine has an array of holes distributed around a flange. The casing may distort when unsupported, but nevertheless the position accuracy of the holes may be checked by manipulating measured hole positions to lie with known deviations from a best-fit circle. The maximum load and stress required to bring the hole array into conformity with the best-fit circle is calculated and compared with a predetermined maximum. The deviation of the hole positions associated with the best-fit circle from nominal positions can also be calculated.

This invention relates to a method of checking positional accuracy of features in a flexible component, and is particularly, although not exclusively, concerned with checking features such as holes in components such as gas turbine casings.

Gas turbine casings are examples of components which are prone to distortion, for example under their own weight, when unsupported. This property can cause difficulties when inspecting such components, for example when checking the positional accuracy of an array of features, such as holes, which have been formed in the component in a machining process. Owing to distortion in the component, the holes move relative to their nominal positions with respect to a measurement datum. In order to avoid this problem, the conventional practice is to support the component during the inspection process in a build simulation fixture which holds the component in a nominal configuration, for example, a configuration which it assumes when fastened to another component. Such build simulation fixtures are, of necessity, large, and this causes handling and storage problems. Also, the fixtures need to be massive in order to prevent them from distorting, and they require regular calibration.

According to the present invention there is provided a method of checking positional accuracy of features in a flexible component in which reference points of the features, in a nominal undeformed condition of the component, lie in nominal positions on a nominal line of predetermined form, the method comprising:
(i) measuring the actual positions of the reference points of the features with the component in a deformed condition;
(ii) generating a smoothed spline passing through or close to the actual positions of the reference points;
(iii) mapping the measured positions of the features on to a best-fit line of the predetermined form;
(iv) determining the maximum deflection of the component required to transform the smoothed spline into coincidence with the best-fit line; and
(v) evaluating whether or not the maximum deflection lies within predetermined limits.

The method may also comprise the step of comparing the actual position of the reference point of each feature with a respective nominal position of that reference point after transformation of the best-fit line into coincidence with the nominal line, and evaluating whether or not any deviation between the respective actual and nominal positions of each reference point falls within a respective predetermined positional tolerance.

The predetermined form of the nominal line may be a circle, although other forms may be possible such as straight or curved lines, ellipses or other non-circular closed shapes. The features may be holes in the component, in which case the reference points may be the hole centrelines.

The component may be an annular component, and the features, such as holes, may be provided in a flange of the component.

The step of mapping the measured positions of the features on to a best-fit line may comprise:
(a) generating a base spline passing through the reference point of each feature;
(b) generating the smoothed spline from the base spline;
(c) determining the deviation of the reference point of each feature from the smoothed spline;
(d) constructing a base line of the predetermined form and having a length equal to the length of the smoothed spline, the reference points being spaced apart along the base line by the same distances as they are spaced apart along the smoothed spline; and
(e) determining constrained positions of the reference points of the features which deviate from the base line by the same respective deviations of the reference points from the smoothed spline.

The constrained positions may be manipulated by translation and/or rotation to achieve a best fit with the nominal hole positions.

If the predetermined form of the nominal line is a circle, a manipulation of the constrained positions may be performed such that, within a group of the reference points of at least some of the features, the maximum positive angular deviation between the respective constrained and nominal positions occurring among those reference points is equal to the maximum negative angular deviation between the constrained and nominal positions occurring among those reference features.

The component may be a casing of a gas turbine engine.

The present invention also provides apparatus for performing a method as defined above, the apparatus comprising:
i) a coordinate measuring machine for measuring the actual positions of the reference points of the features with the component in a deformed condition; and
ii) processing equipment adapted to
   a) generate a smoothed spline passing through or close to the actual positions of the reference points;
   b) map the measured positions of the features on to a best-fit line of the predetermined form;
   c) determine the maximum deflection of the component required to transform the smoothed spline into coincidence with the best-fit line;
   d) evaluate whether or not the maximum deflection lies within predetermined limits.

For a better understanding of the present invention, and to show more clearly how it may be carried into effect, reference will now be made, by way of example, to the accompanying drawings, in which:

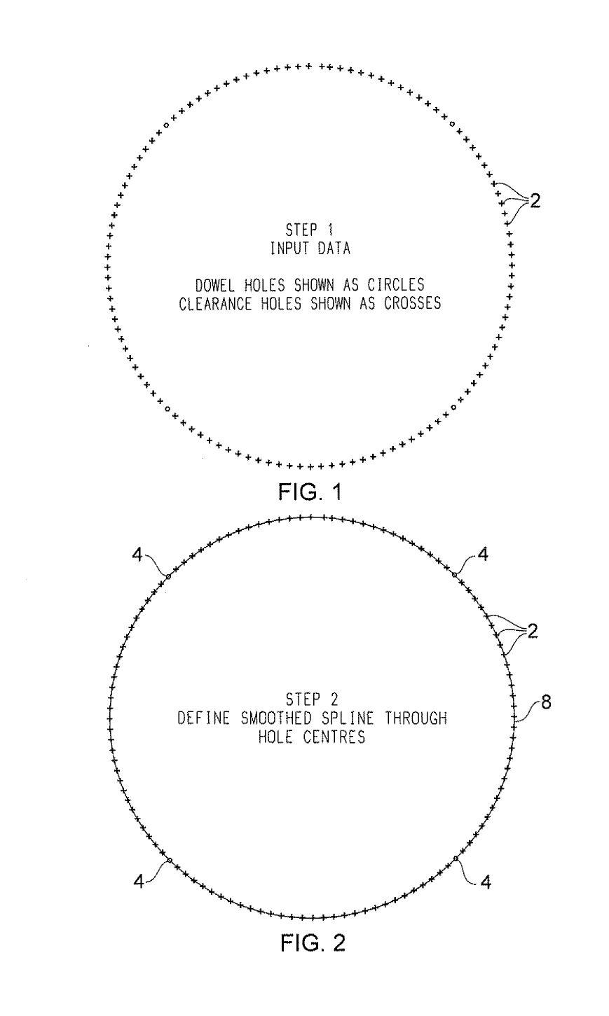

FIG. 1 represents measured positions of the centrelines of an array of holes in a flange of a gas turbine engine casing;

FIG. 2 shows a smoothed spline extending around the array of holes;

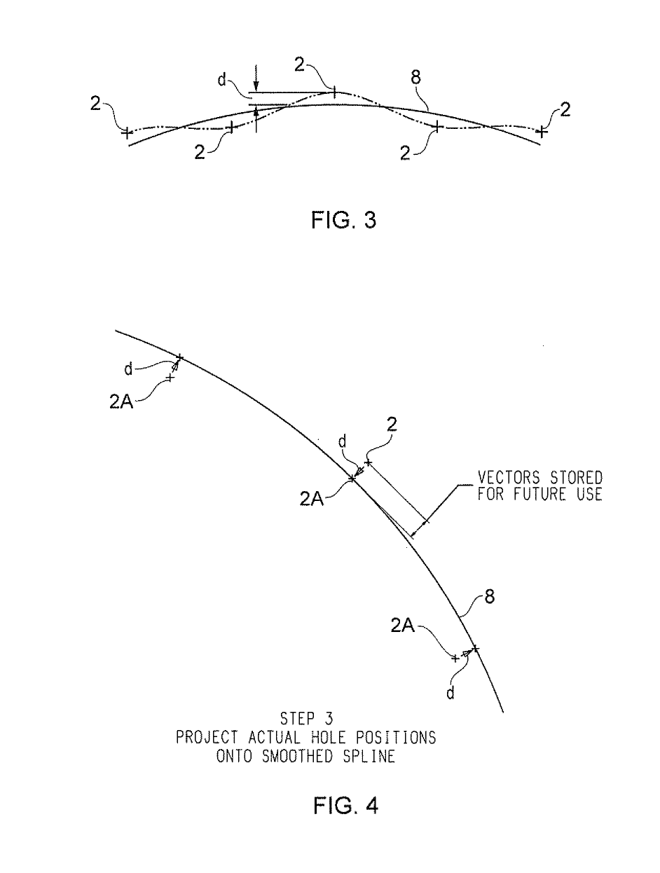

FIG. 3 is an enlarged view of a region of the smoothed spline FIG. 2;

FIG. 4 indicates relationships between hole centreline positions and the smoothed spline;

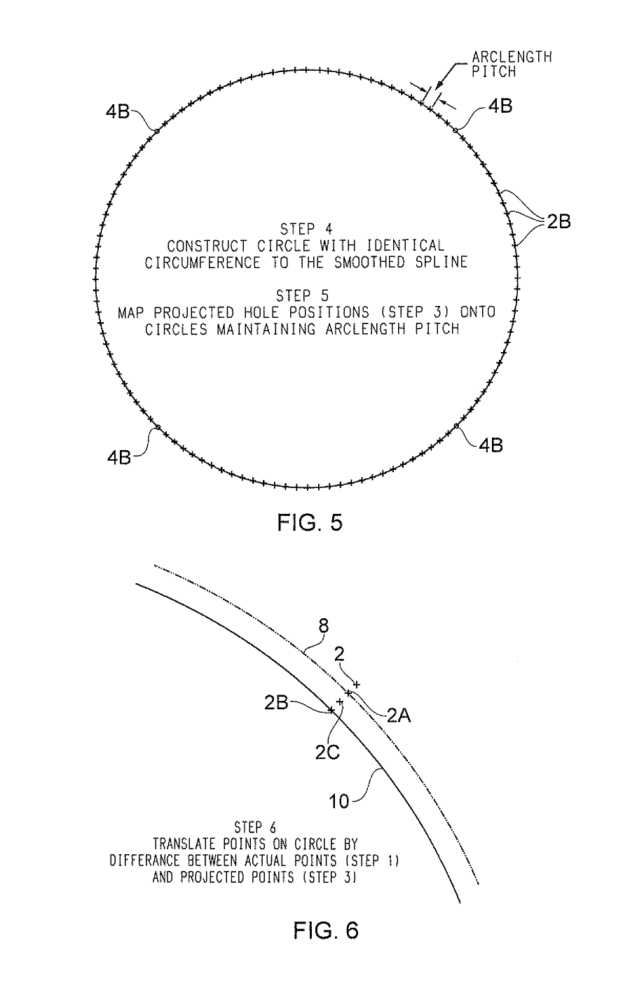

FIG. 5 shows a circle onto which the hole centrelines are mapped;

FIG. 6 shows the relationship between constrained hole centreline positions and the circle of FIG. 5;

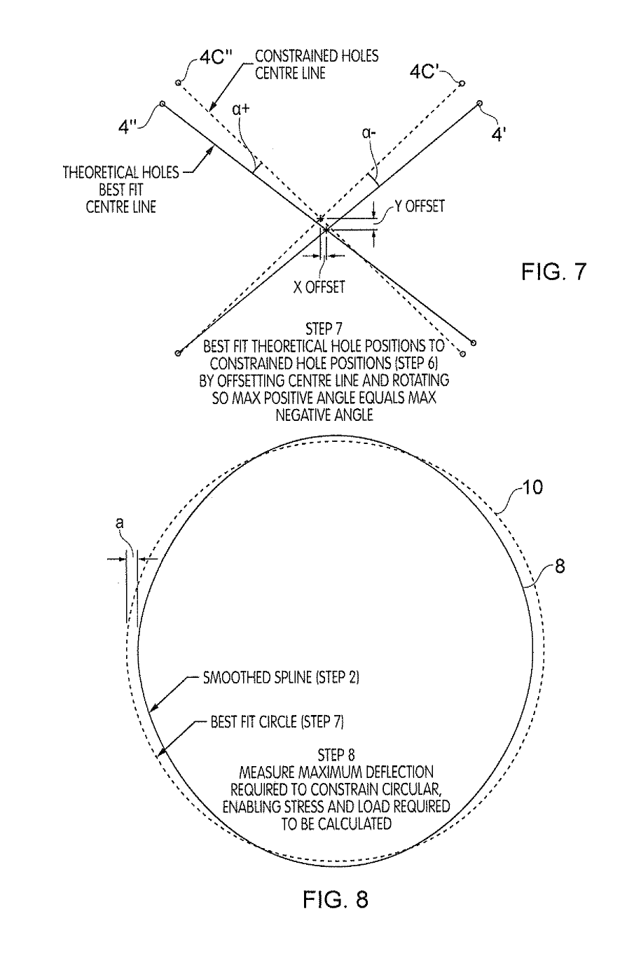

FIG. 7 represents a transformation to provide a best-fit between the hole centreline positions on the circle of FIG. 5 and nominal positions of the hole centrelines; and

FIG. 8 represents, in an exaggerated form, the relationship between the smoothed spline of FIG. 2 and the best-fit circle following the transformation of FIG. 7.

The array of holes shown in FIG. 1 comprises clearance holes 2 indicated by crosses, and dowel holes 4 indicated as circles. The holes 2, 4 are formed in a machining operation, performed on the casing, and the casing is subsequently inspected in a CMM process, to determine whether or not it falls within predetermined tolerances. The holes 2, 4 serve to locate the casing with respect to another component of the engine and to receive fasteners to secure the casing to the other component. Consequently, it is important that the holes are accurately positioned. However, although the holes 2, 4 appear to lie on a true circle as seen in FIG. 1, the individual holes 2, 4 deviate slightly from the circle owing to the flexibility of the engine casing which causes it to deform when it is unsupported following the machining operation.

The CMM process creates position data for the centrelines of the holes 2, 4 in the deformed condition of the casing. This position data is supplied to a processor which, as shown in FIG. 3, generates a spline 6 which passes precisely through the centrelines of all of the holes 2,4. This spline is then smoothed in the processor to create a smoothed spline 8. In the smoothing process, the line of the spline is moved away from some or all of the hole centrelines. Consequently, the deviations d of the hole positions from the smoothed spline 8 can be regarded as “noise” in the overall hole pattern defined by the smoothed spline 8.

The smoothed spline 8 may be derived by performing a smoothing process on the original spline 6, but alternatively the smoothed spline 8 may be derived from a spigot location diameter based on the positions of the dowel holes 4.

The actual positions of the holes 2, 4 are projected onto the smoothed spline 8 to define projected hole positions 2A, and the individual deviations d of the actual positions of the centrelines of the holes 2,4 from the smoothed spline 8 are then recorded, as indicated in FIG. 4.

In the next step, a true circle is generated having a circumference which is identical to the peripheral length of the smoothed spline 8. The projected hole positions 2A on the smoothed spline 8 are mapped onto the circle 10 as projected hole positions 2B so that the distance along the circular arc of the circle 10 between adjacent projected positions is identical, for each respective pair of adjacent holes 2, 4, to the corresponding length along the smoothed spline 8.

Subsequently, using the deviations d recorded as described with reference FIG. 4, the projected hole positions 2B on the circle 10 are adjusted to establish constrained hole positions 2C. Thus, the deviation d between the actual hole position 2 and the hole position 2A projected on to the smoothed spline 8 is the same as the deviation between the hole position 2B projected on to the circle 10 and the constrained hole position 2C.

As shown in FIG. 7, the circle 10 is then transformed by both translation and rotation to achieve a best-fit between the constrained hole positions 2C, 4C and the nominal or theoretical hole positions 2, 4 derived from drawing data representing the intended form of the component. This transformation results in an offset X,Y as indicated in FIG. 7 in the relative positions of the constrained hole positions 2C, 4C and the nominal positions 2, 4, and rotation of the circle 10, with the constrained hole positions 2C, 4C about the centre of the circuit 10 until the maximum positive angle α+ between one respective pair of constrained and nominal hole positions 4C′, 4′ is equal to the maximum negative angle α− between another respective pair of constrained and nominal hole positions 4C″, 4″. It will be appreciated that, in the embodiment shown, the dowel holes 4 are used for this purpose, since it is desirable to base the correlation between the arrays of holes on the smoothed spline 8 and the best-fit circle 10 on locations which have a high accuracy requirement. Nevertheless, it is possible to use other groups of the holes 2, 4 to serve as the reference basis for this rotational adjustment.

FIG. 8 shows the best-fit circle 10, derived from the step referred to with regard to FIG. 7, superimposed on the smoothed spline 8. It will be appreciated that the process described with reference to FIGS. 1-7 yields the circle 10 which is the best fit of the measured holes 2, 4 of FIG. 1 on a true circle. From FIG. 8, it is possible to establish the largest deflection a which the component needs to undergo in order to displace the actual positions of the holes 2, 4 as shown in FIG. 1 on to the best-fit circle 10. Utilising a 3D model of the component flange, the maximum load and stress are then calculated that would be produced by the required deformation of the flange to bring the smoothed spline 8 into coincidence with the best-fit circle 10. The calculated load and stress are then compared with predetermined values to establish whether or not the required flange deformation can be achieved without overstressing of the flange.

As a further step, actual position errors of the holes 2, 4 with respect to the best-fit circle 10 following the transformation described with reference to FIG. 7 can be calculated on the basis of the maximum metal condition as prescribed by detail drawing requirements. This enables the creation of an output in the form of the following table:

MAXIMUM DEFLECTION = 0.32 mm
REQUIRED
LOAD REQUIRED = 30 N
MAX STRESS = 15 Mpa
ALL HOLES PASS POSITIONAL CHECK

| HOLE | ACTUAL | MAX | |
|---|---|---|---|
| NUMBER | ERROR | ERROR | STATUS |
| 1 | 0.028 | 0.512 | PASSED |
| . . . | . . . | . . . | . . . |
| . . . | . . . | . . . | . . . |
| . . . | . . . | . . . | . . . |
| 100 | 0.376 | 0.507 | PASSED |

It will be appreciated that the present invention provides a process by which position errors in features such as holes can be evaluated when measurement of the hole positions is performed while the component is in a deformed condition. Manipulation of the hole data creates a model of the hole array which conforms in shape to the nominal form (i.e. is circular in the embodiment described) while retaining any positioning errors. That model is then compared with a smoothed spline generated from the actual hole positions to determine whether or not the component can be adjusted to return the hole array to its nominal shape without overstressing or overloading the component, and errors in hole position can be determined.

The process may be conducted on a coordinate measurement machine provided with a processor for carrying out the various calculating and transforming steps, without needing to physically support the component in its nominal shape, or its shape when assembled with neighbouring components.

1. A method of inspecting a flexible component, the component having features in which reference points of the features, in a nominal undeformed condition of the component, lie in nominal positions on a nominal line of predetermined form, the method comprising:
(i) measuring the actual positions of the reference points of the features with the component in a deformed condition;
(ii) generating a smoothed spline passing through or close to the actual positions of the reference points;
(iii) mapping the measured positions of the features on to a best-fit line of the predetermined form;
(iv) determining the maximum deflection of the component required to transform the smoothed spline into coincidence with the best-fit line; and
(v) evaluating whether or not the maximum deflection lies within predetermined limits.

2. A method as claimed in claim 1, further comprising the step of comparing the actual position of the reference point of each feature with a respective nominal position of that reference point after transformation of the smoothed spline into coincidence with the best-fit line, and evaluating whether or not any deviation between the respective actual and nominal positions of each reference point falls within a respective predetermined positional tolerance.

3. A method as claimed in claim 1, in which the predetermined form of the nominal line is a circle.

4. A method as claimed in claim 1, in which the features are holes in the component.

5. A method as claimed in claim 4, in which the reference points are the centrelines of the holes.

6. A method as claimed in claim 1, in which the component is an annular component, and the features are provided in a flange of the component.

7. A method as claimed in claim 1, in which the step of mapping the measured positions of the features on to a best-fit line comprises;
(a) generating a base spline passing through the reference point of each feature;
(b) generating the smoothed spline from the base spline;
(c) determining the deviation of the reference point of each feature from the smoothed spline;
(d) constructing a base line of the predetermined form and having a length equal to the length of the smoothed spline, the reference points being spaced apart along the base line by the same distances as they are spaced apart along the smoothed spline; and
(e) determining constrained positions of the reference points of the features which deviate from the base line by the same respective deviations of the reference points from the smoothed spline.

8. A method as claimed in claim 7, in which the constrained positions of the reference points are manipulated collectively to achieve the best-fit with the nominal positions of the reference points.

9. A method as claimed in claim 8, in which the constrained positions are manipulated by translation and/or rotation.

10. A method as claimed in claim 7, in which the predetermined form of the nominal line is a circle and manipulation of the constrained positions is performed such that, within a group of the reference points of at least some of the features, the maximum positive angular deviation between the respective constrained and nominal positions occurring among those reference points is equal to the maximum negative angular deviation between the constrained and nominal positions occurring among those reference features.

11. A method as claimed in claim 1, in which the component is a casing of a gas turbine engine.

12. Apparatus for performing a method in accordance with claim 1, the apparatus comprising:
i) a coordinate measuring machine for measuring the actual positions of the reference points of the features with the component in a deformed condition; and
ii) processing equipment adapted to
a) generate a smoothed spline passing through or close to the actual positions of the reference points;
b) map the measured positions of the features on to a best-fit line of the predetermined form;
c) determine the maximum deflection of the component required to transform the smoothed spline into coincidence with the best-fit line;
d) evaluate whether or not the maximum deflection lies within predetermined limits.
